(19) United States
(12) Patent Application Publication
(10) Pub. No.: US 2011/0204036 A1
(43) Pub. Date: Aug. 25, 2011

(54) HEAT TREATMENT APPARATUS

(75) Inventors: Masaki MUROBAYASHI, Toyama (JP); Takatomo YAMAGUCHI, Toyama (JP); Kenji SHIRAKO, Toyama (JP); Shuhei SAIDO, Toyama (JP); Akihiro SATO, Toyama (JP); Daisuke HARA, Toyama (JP)

(73) Assignee: Hitachi Kokusai Electric Inc., Tokyo (JP)

(21) Appl. No.: 13/029,499

(22) Filed: Feb. 17, 2011

(30) Foreign Application Priority Data
Feb. 23, 2010 (JP) 2010-037066
Dec. 9, 2010 (JP) 2010-274389

(51) Int. Cl. H05B 1/00

(52) U.S. Cl. 219/201

(57) ABSTRACT

Provided is a heat treatment apparatus having a temperature detection unit installed outside a reaction chamber and capable of preventing a process gas from contacting the temperature detection unit to form a film and improving reliability and reproduction of a measurement value of the temperature detection unit. The heat treatment apparatus for growing a single crystalline film or polycrystalline films on a plurality of substrates includes a boat configured to hold the plurality of substrates, a cylindrical heat generating material (23) installed to surround the boat and constituting a reaction chamber (32), a reaction tube (21) installed to surround the cylindrical heat generating material, a cylindrical insulating part (25) installed between the cylindrical heat generating material and the reaction tube, a temperature measurement chip (24) installed between the cylindrical heat generating material and the cylindrical insulating part, and a radiation thermometer (42) configured to measure a temperature of the temperature measurement chip, wherein the radiation thermometer is disposed below a lower end of the reaction tube.

### CROSS-REFERENCE TO RELATED PATENT APPLICATION

This application claims priority to and the benefit of Japanese Patent Application Nos. 2010-037066 filed on Feb. 23, 2010 and 2010-274389 filed on Dec. 9, 2010, the disclosure of which is incorporated herein by reference.

### FIELD OF THE INVENTION

The present invention relates to a heat treatment apparatus for performing heat treatment such as generation of a thin film on a substrate such as a silicon wafer, diffusion of impurities, and etching, and more particularly, to a heat treatment apparatus for growing a silicon carbide (SiC) film on a SiC wafer.

### DESCRIPTION OF THE RELATED ART

As shown in FIG. 8, in a conventional heat treatment apparatus, a boat 74 is accommodated as a substrate holder in a reaction chamber 76 partitioned in a reaction tube 79 made of quartz as a major element, a plurality of substrates (wafers) 73 are held by the boat 74 in multiple stages in a vertical direction, and a cylindrical heat generating material 72 installed to surround the boat 74 is induction-heated to a predetermined temperature by a heating coil 77 arranged outside the reaction tube 79, thus performing a film forming process.

Here, in order to prevent the reaction tube 79 or a housing from being heated by a radiant heat from the cylindrical heat generating material 72, an insulating material 80 is installed between the reaction tube 79 and the cylindrical heat generating material 72, and held by an insulating casing formed of quartz as a major element. In addition, the insulating material 80 may be made of a material that resists a high temperature and has a small amount of impurities, generally carbon.

Heating of the cylindrical heat generating material 72 is controlled based on a detection result of a temperature detection unit installed in the cylindrical heat generating material 72, and the temperature detection unit may be a control thermocouple (TC) 71 installed in the reaction tube 79, or a radiation thermometer 78 (see FIG. 9) for detecting a radiant light from the wafers 73 or the cylindrical heat generating material 72.

In the conventional heat treatment apparatus, when a heating temperature of the cylindrical heat generating material 72 is observed or controlled using the control TC 71, the control TC 71 is installed in the cylindrical heat generating material 72 together with the wafers 73, the boat 74 and a gas supply nozzle 75, and protected by a protection tube formed of a metal with a high melting temperature such as molybdenum or tantalum, or sapphire.

During the film forming process, the control TC 71 detects a temperature in the reaction chamber 76, a detected result is fed back to a temperature control unit (not shown), and the temperature control unit is configured to apply a current to the heating coil 77 based on the detected result of the control TC 71.

However, since the protection tube is etched by hydrogen in a high temperature field, an element from the etched protection tube may enter the wafers 73, thus contaminating the wafers 73. In addition, since the SiC film is formed on the protection tube, the temperature detected by the control TC 71 may vary as time elapses.

In addition, as shown in FIG. 9, when the heating temperature of the cylindrical heat generating material 72 is observed or controlled using the radiation thermometer 78, the radiation thermometer 78, which may be one or more, is installed outside the reaction tube 79, and a hole 81 may be punched in a place of the insulating material 80 opposite to the radiation thermometer 78.

During the film forming process, the radiant light from an outer circumferential part of the cylindrical heat generating material 72 passed through the insulating casing 82 and the reaction tube 79 via the hole 81 punched in the insulating material 80 is detected by the radiation thermometer 78, and temperature observation and control for heating, maintaining and cooling of the reaction chamber 76 are performed based on the detected result.

However, an insulating effect is partially decreased due to the hole 81 punched to detect the radiant light of the cylindrical heat generating material 72 using the radiation thermometer 78, and a temperature distribution on a surface of the cylindrical heat generating material 72 and in the reaction chamber 76 is deteriorated. As a result, uniformity in treatment of the wafers 73 held by the boat 74 is damaged, a temperature of the insulating casing 82 and the reaction tube 79 exceeds a heat-resistant temperature of quartz due to the radiant heat from the cylindrical heat generating material 72, and thus, the insulating casing 82 and the reaction tube 79 may be broken.

In addition, when the hold 81 is punched in the insulating material 80 to directly measure the temperature of the cylindrical heat generating material 72, since the radiant light detected by the radiation thermometer 78 passes through both the insulating casing 82 and the reaction tube 79, refraction due to the quartz occurs and accurate temperature measurement becomes difficult.

In addition, the temperature of the reaction chamber 76 and the wafers 73 may be directly measured using the radiation thermometer 78. In this case, since a viewport of the radiation thermometer 78 formed of quartz and through which the radiant light passes is in direct contact with a process gas or a clean gas, a byproduct is stuck to the viewport, and the accurate temperature measurement becomes difficult as time elapses.

Further, Patent Document 1 discloses a semiconductor heat treatment apparatus, in which a temperature of a wafer is predicted based on a specifically measured result of temperature distribution of an inner wall of a processing chamber, and an optimal temperature set to a heater is analytically obtained, thus performing a temperature control.

### [Prior Art Document]

### [Patent Document]

[Patent Document 1] Japanese Patent Laid-open Publication No.: H05-267200

### SUMMARY OF THE INVENTION

In consideration of the above circumstances, it is an object of the present invention to provide a heat treatment apparatus, in which a temperature detection unit is installed outside a reaction chamber, capable of preventing a process gas from contacting the temperature detection unit to form a film, and improving reliability and reproduction of a measurement value of the temperature detection unit.

In consideration of the above circumstances, it is another object of the present invention to provide a heat treatment apparatus capable of preventing deterioration of a temperature distribution in a reaction chamber generated by a hole punched in an insulating material and influence of radiant heat from the hole on a quartz material, and stably performing a temperature control without a measurement error.

According to an aspect of the present invention, there is provided a heat treatment apparatus for growing single crystalline films or polycrystalline films on a plurality of substrates, which includes: a boat configured to hold the plurality of substrates; a cylindrical heat generating material installed to surround the boat and constituting a reaction chamber; a reaction tube installed to surround the cylindrical heat generating material; a cylindrical insulating part installed between the cylindrical heat generating material and the reaction tube; a temperature measurement chip installed between the cylindrical heat generating material and the cylindrical insulating part; and a radiation thermometer configured to measure a temperature of the temperature measurement chip, wherein the radiation thermometer is disposed below a lower end of the reaction tube.

In addition, a cylindrical protection tube may be installed between the temperature measurement chip and the radiation thermometer to surround an optical path through which radiant light emits from the temperature measurement chip, and the temperature measurement chip may be fixed to an upper end of the protection tube.

According to another aspect of the present invention, there is provided a heat treatment apparatus for growing single crystalline films or polycrystalline films on a plurality of substrates, which includes: a boat configured to hold the plurality of substrates; a cylindrical heat generating material installed to surround the boat and constituting a reaction chamber; a reaction tube installed to surround the cylindrical heat generating material; a cylindrical insulating part installed between the cylindrical heat generating material and the reaction tube; a thermocouple installed between the cylindrical heat generating material and the cylindrical insulating part; a protection tube configured to protect the thermocouple; and a heating coil to which a radio frequency current is applied to heat the cylindrical heat generating material, wherein the protection tube is made of a member which has a resistance higher than that of the cylindrical heat generating material and is not easily induction-heated by the heating coil.

In addition, the protection tube may be made of sapphire.

### BRIEF DESCRIPTION OF THE DRAWINGS

FIG. 1 is a perspective view of a heat treatment apparatus of the present invention;

FIG. 2 is a vertical cross-sectional view of a processing furnace of the heat treatment apparatus of a first embodiment of the present invention;

FIG. 3 an enlarged vertical cross-sectional view of the processing furnace of the first embodiment of the present invention;

FIG. 4 is a schematic vertical cross-sectional view of a processing furnace and peripheral components of a second embodiment of the present invention;

FIG. 5 is an enlarged cross-sectional view of the processing furnace of the second embodiment of the present invention;

FIG. 6 shows a processing furnace of a third embodiment of the present invention, FIG. 6A showing a schematic perspective view of a reaction tube and a cylindrical heat generating material, and FIG. 6B showing a cross-sectional view taken along line A-A of FIG. 6A.

FIG. 7 shows a processing furnace of a seventh embodiment of the present invention, FIG. 7A showing a schematic vertical cross-sectional view of the processing furnace, and FIG. 7B showing a cross-sectional view taken along line B-B of FIG. 7A;

FIG. 8 shows a conventional processing furnace, FIG. 8A showing a schematic vertical cross-sectional view of the processing furnace using a control TC, and FIG. 8B showing a cross-sectional view taken along line C-C of FIG. 8A;

FIG. 9 shows another conventional processing furnace, FIG. 9A showing a schematic vertical cross-sectional view of the processing furnace using a radiation thermometer, and FIG. 9B showing a cross-sectional view taken along line D-D of FIG. 9A;

FIG. 10 shows a processing furnace of a fourth embodiment of the present invention, FIG. 10A showing a schematic perspective view of a reaction tube and a cylindrical heat generating material, and FIG. 10B showing a cross-sectional view taken along line E-E of FIG. 10A;

FIG. 11A through 11D are views for explaining an installation method of a temperature measurement chip of the fourth embodiment of the present invention;

FIG. 12 is an enlarged vertical cross-sectional view of a processing furnace of a fifth embodiment of the present invention;

FIG. 13 shows the processing furnace of the fifth embodiment of the present invention, FIG. 13A showing a schematic perspective view of a reaction tube and a cylindrical heat generating material, and FIG. 13B showing a cross-sectional view taken along line F-F of FIG. 13A;

FIG. 14 shows a processing furnace of a sixth embodiment of the present invention, FIG. 14A showing a schematic perspective view of a reaction tube and a cylindrical heat generating material, and FIG. 14B showing a cross-sectional view taken along line G-G of FIG. 14A;

FIGS. 15A and 15B are front views showing modified examples of a protection tube of the sixth embodiment of the present invention; and

FIG. 16 shows the processing furnace of the seventh embodiment of the present invention, FIG. 16A showing an enlarged view of the processing furnace, and FIG. 16B showing a partial enlarged view of a portion FIG. 16A.

### DETAILED DESCRIPTION OF THE PREFERRED EMBODIMENTS

Hereinafter, embodiments of the present invention will be described with reference to the accompanying drawings.

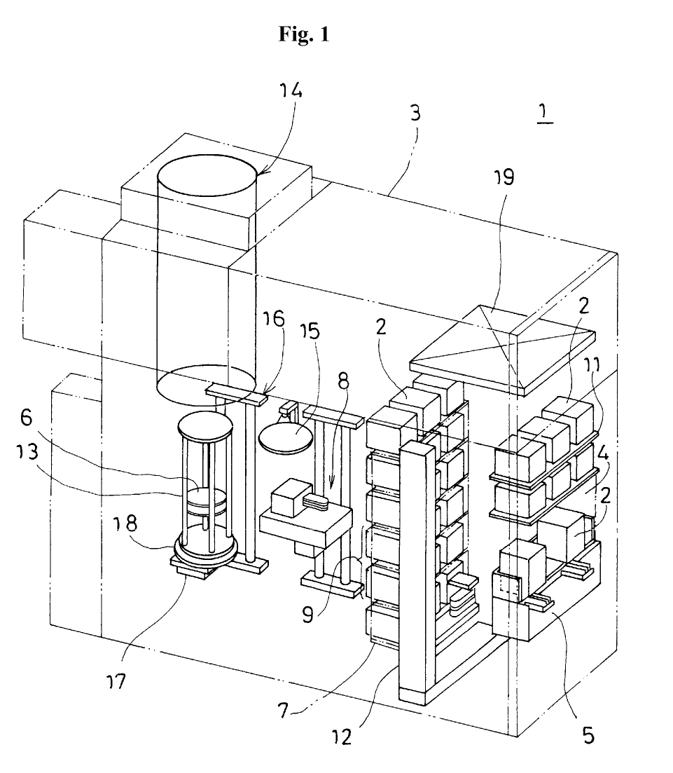

First, in FIG. 1, an example of a heat treatment apparatus of the present invention will be described. In the heat treatment apparatus 1 in accordance with the present invention, a wafer 6, which is a silicon carbide (SiC) substrate, is accommodated in a cassette 2 as a substrate accommodating vessel to be loaded and unloaded.

The heat treatment apparatus 1 includes a housing 3, and a cassette loading/unloading port 4 is installed at a front wall of the housing 3 to be opened and closed by a front shutter (not shown). A cassette stage 5 is installed adjacent to the cassette loading/unloading port 4 in the housing 3.

The cassette 2 is loaded onto the cassette stage 5 by an in-process conveying device (not shown), and unloaded from the cassette stage 5. The cassette stage 5 is placed such that the wafer 6 in the cassette 2 is vertically disposed and a wafer inlet/outlet port of the cassette 2 is directed upward by the in-process conveying device, and the cassette stage 5 is rotated such that the wafer inlet/outlet port of the cassette 2 is directed to a rear side of the housing 3.

A cassette shelf (a substrate acceptor placing shelf) 7 is installed at a substantial center part in the housing 3 in a longitudinal direction thereof, and the cassette shelf 7 is configured such that a plurality of cassettes 2 are stored in a plurality of rows and columns. A transfer shelf 9, in which the cassette 2 to be conveyed by a wafer transfer device 8 is accommodated, is installed at the cassette shelf 7. In addition, a preliminary cassette shelf 11 is installed over the cassette state 5 to preliminarily store the cassette 2.

A cassette conveying device 12 is installed between the cassette stage 5 and the cassette shelf 7. The cassette conveying device 12 is configured to convey the cassette 2 among the cassette stage 5, the cassette shelf 7, and the preliminary cassette shelf 11.

A processing furnace 14 is installed at a rear upper part of the housing 3, and a lower end opening (furnace port) of the processing furnace 14 is configured to be opened and closed by a furnace port shutter 15. As a lift mechanism for lifting a boat 13 and moving the boat 12 into/from the processing furnace 14, a boat elevator 16 is installed below the processing furnace 14. The boat elevator 16 includes a lift arm 17, a seal cap 18 is horizontally installed as a lid body at the lift arm 17, and the seal cap 18 is configured to vertically support the boat 13 and open/close the furnace port. A clean unit 19 for supplying clean air in a clean atmosphere is installed over the cassette shelf 7, and the clean unit 19 is configured to distribute the clean air in the housing 3.

Hereinafter, an operation of the heat treatment apparatus 1 of the present invention will be described. The cassette loading/unloading port 4 is opened and the cassette 2 is supplied to the cassette stage 5. Thereafter, the cassette 2 is loaded from the cassette loading/unloading port 4, conveyed to the cassette shelf 7 or the preliminary cassette shelf 11 by the cassette conveying device 12 and temporarily stored, and then, transferred from the cassette shelf 7 or the preliminary cassette shelf 11 to the transfer shelf 9 by the cassette conveying device 12 or directly conveyed to the transfer shelf 9.

When the cassette 2 is transferred to the transfer shelf 9, the wafer 6 is charged into the boat 13 lowered from the cassette 2 by the wafer transfer device 8.

When a predetermined number of non-processed wafers 6 are charged into the boat 13, a lower end of the processing furnace 14 closed by the furnace port shutter 15 is opened by the furnace port shutter 15, and the boat 13 is loaded into the processing furnace 14, thus performing a predetermined treatment of the wafers 6. Next, the boat 13 is lowered, the wafers 6 processed by the wafer transfer device 8 are transferred to the cassette 2, and the cassette 2 in which the processed wafers 6 are loaded is discharged to an outside of the housing 3.

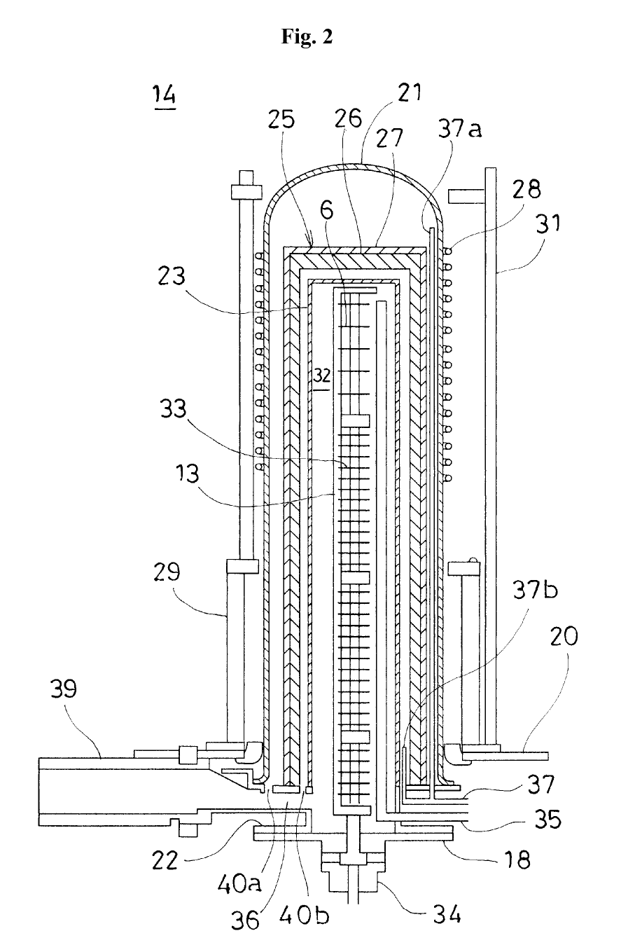

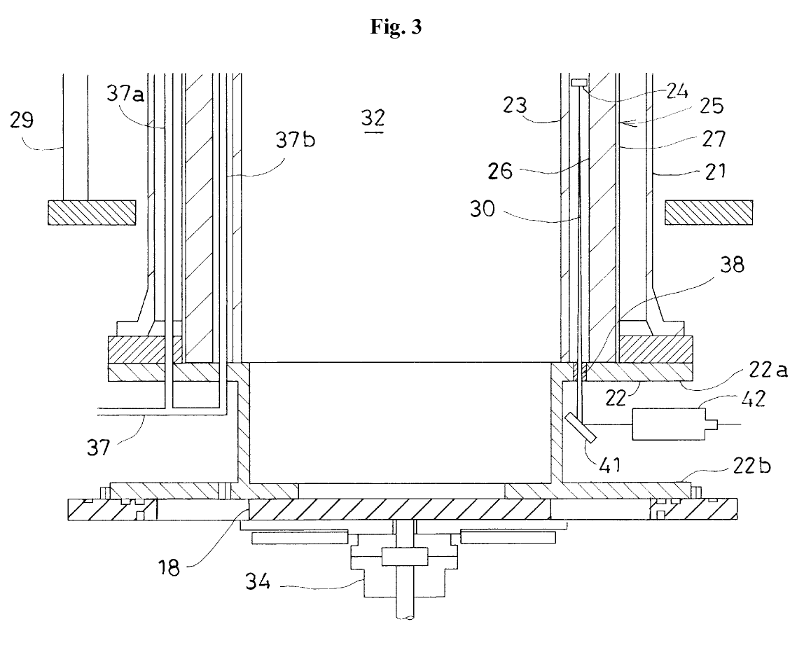

Next, in FIGS. 2 and 3, the processing furnace 14 of the first embodiment of the present invention will be described in detail.

A reaction tube 21 for processing the wafers 6, which are SiC substrates, is provided, a cylindrical inlet flange 22 formed of, for example, stainless steel and having an upper flange 22a and a lower flange 22b formed at upper and lower ends thereof is hermetically installed at a lower end of the reaction tube 21, the lower end opening of the inlet flange 22 forms the furnace port, and the furnace port is alternatively closed by any one of the furnace port shutter 15 and the seal cap 18. A cylindrical heat generating material 23 with a ceiling is vertically installed at the inlet flange 22 in the reaction tube 21 to cover the boat 12 when the boat 13 is inserted thereinto, and a temperature measurement chip 24 having a rectangular shape and made of the same material as the cylindrical heat generating material 23 protrudes from an outer circumference of the cylindrical heat generating material 23.

In addition, a cylindrical insulating part 25 with a ceiling is disposed between the cylindrical heat generating material 23 and the reaction tube 21 and vertically installed at the inlet flange 22 to cover the cylindrical heat generating material 23. The insulating part 25 has a dual structure, in which an insulating material 26 installed at an inner layer and formed of carbon felt and an insulating casing 27 installed at an outer layer are integrated with each other.

A heating coil 28 is installed outside an upper part of the reaction tube 21 to surround the reaction tube 21 and electrically connected to a temperature control unit (not shown) so that heating by the heating coil 28 is controlled by the temperature control unit. In addition, the heating coil 28 is, for example, supported by a support post 29 made of a ceramic material such as an insulating material such as alumina, the support post 29 is covered by a water-cooling wall for cooling the reaction tube 21 and an outer wall 31 such as a housing cover for preventing a leakage of an electromagnetic wave and heat to the exterior, and the support post 29 and the outer wall 31 are supported by a heater base 20.

Further, a reaction chamber 32 is partitioned by at least the cylindrical heat generating material 23, the inlet flange 22 and the seal cap 18.

In a state in which the boat 13 is inserted into the reaction chamber 32, the wafers 6 are charged into the boat 13 at a position opposite to the heating coil 28, an insulating plate 33 is installed below the wafers 6, and thus, increase in temperature of a seal member (not shown) installed at the reaction tube 21, the inlet flange 22, and a connection part of the inlet flange 22 and the seal cap 18 is suppressed.

Furthermore, the seal cap 18 is supported by a boat rotation mechanism 34. As the boat rotation mechanism 34 is rotated, the boat 13 is also rotated.

In addition, a process gas supply nozzle 35 connected to a gas supply pipe (not shown) passes through a circumferential surface of the inlet flange 22, and a gas exhaust port 36 is formed in the circumferential surface. Further, a purge gas supply nozzle 37 connected to a purge gas supply pipe and a purge gas supply source (not shown) passes through the upper flange 22a of the inlet flange 22, a hole is formed in the upper flange 22a at a position opposite to the temperature measurement chip 24, and a viewport 38 made of quartz is installed to fill the hole. Furthermore, a first purge gas exhaust port 40a is punched in the upper flange 22a at a position opposite to a first purge gas supply nozzle 37a to be described below, and a second purge gas exhaust gas 40b is punched in the upper flange 22a at a position opposite to a second purge gas supply nozzle 37b to be described below.

The process gas nozzle 35 connected to a process gas supply pipe and a process gas supply source (not shown) passes through the inlet flange 22 from the circumferential surface and extends along a wall surface of the cylindrical heat generating material 23 in a vertical direction thereof, and a process gas and a clean gas are supplied into the reaction chamber 32 through a plurality of process supply gas supply holes (not shown) punched in a vertical part at predetermined intervals.

In addition, the gas exhaust port 36 is connected to a gas cooler 39, and the gas cooler 38 is connected to an exhaust device such as a vacuum pump (not shown), and a gas heated in the reaction chamber 32 to 1500° C. through 1800° C. is cooled by the gas cooler 39 to be discharged from the exhaust device.

The purge gas supply nozzle 37 is split into two lines under the upper flange 22a. One line is the first purge gas supply nozzle 37a passing through the upper flange 22a and extending from between the reaction tube 21 and the insulating casing 27 in a vertical direction so that an atmosphere between the reaction tube 21 and the insulating casing 27 is purged by a purge gas, which is an inert gas such as argon gas, supplied from the first purge gas supply nozzle 37a.

In addition, the other line is the second purge gas supply nozzle 37b passing through the upper flange 22a and extending from between the cylindrical heat generating material 23 and the insulating material 26 in a vertical direction so that an atmosphere between the cylindrical heat generating material 23 and the insulating material 26 is purged by a purge gas supplied from the second purge gas supply nozzle 37b. Further, the second purge gas supply nozzle 37b is installed not to interfere with the temperature measurement chip 24.

In addition, a radiant light reflective mirror 41 and a radiant thermometer 42 serving as a temperature detection unit are installed at a space between the upper flange 22a and the lower flange 22b. The radiant light reflective mirror 41 is opposite to the temperature measurement chip 24 via the viewport 38. The radiation thermometer 42 receives radiant light 30 such as infrared light emitted from the temperature measurement chip 24 and reflected by the radiant light reflective mirror 41. A temperature of the temperature measurement chip 24 is measured by the radiant light 30, and a measurement result may be fed back to the temperature control unit (not shown).

Further, since the temperature measurement chip 24 is made of the same material as the cylindrical heat generating material 23 and the temperature measurement chip 24 protrudes from the cylindrical heat generating material 23, the temperature measurement chip 24 is heated similar to the cylindrical heat generating material 23 and a temperature of the temperature measurement chip 24 becomes equal to a temperature of the cylindrical heat generating material 23. Accordingly, the temperature of the cylindrical heat generating material 23 can be accurately measured by measuring the temperature of the temperature measurement chip 24.

When a film forming process is performed, first, the boat 13 in which the predetermined number of wafers 6 and the insulating plate 33 are charged is loaded into the reaction chamber 32.

Next, the process gas such as monosilane or propane is introduced into the reaction chamber 32 from the process gas supply source (not shown) via the process gas supply nozzle 35, and, for example, a radio frequency current of 30 kHz is applied to the heating coil 28. The radio frequency current is applied to the heating coil 28 to generate an alternate magnetic field, an induction current is generated from the cylindrical heat generating material 23 by the alternate magnetic field, an over current flows through the cylindrical heat generating material 23 by the induction current, the cylindrical heat generating material 23 is heated by Joule heat, and the temperature measurement chip 24 is also heated similar to the cylindrical heat generating material 23.

In addition, during introduction of the process gas, the purge gas is supplied from the purge gas supply source (not shown) into the space between the reaction tube 21 and the insulating casing 27 via the first purge gas supply nozzle 37a, and simultaneously, the purge gas is introduced into the space between the cylindrical heat generating material 23 and the insulating material 26 via the second purge gas supply nozzle 37b.

By heating the cylindrical heat generating material 23, the boat 13 and the wafers 6 covered by the cylindrical heat generating material 23 are heated by the radiant heat from the cylindrical heat generating material 23 to a predetermined temperature, and SiC crystalline films are formed on the wafers 6 by the activated process gas. When the film forming process ends, the purge gas introduced from the first purge gas supply nozzle 37a is exhausted through the first purge gas exhaust port 40a, the purge gas introduced from the second purge gas supply nozzle 37b is exhausted through the second purge gas exhaust port 40b, simultaneously, the process gas in the reaction chamber 32 is exhausted through the gas exhaust port 36 by an exhaust device (not shown), and then, the boat 13 is unloaded from the reaction chamber 32.

During the process, the radiant light 30 emitted from the temperature measurement chip 24 passes through the viewport 38, and is then reflected by the radiant light reflective mirror 41 to enter the radiation thermometer 42. As the radiation thermometer 42 detects the radiant light 30 to always measure the temperature of the cylindrical heat generating material 23, the measured result is fed back to the temperature control unit (not shown), and the temperature control unit applies the radio frequency current to the heating coil 28 based on the fed-back measured result, thus controlling the temperature of the cylindrical heat generating material 23.

In addition, the insulating part 25 blocks the radiant heat from the heated cylindrical heat generating material 23 and suppresses heat transfer to the reaction tube 21 and the outer wall 31, and the insulating plate 33 blocks the radiant heat from the wafers 6 or the boat 13 and suppresses heat transfer to the inlet flange 22 or the viewport 38.

Therefore, since the inlet flange 22, at which the viewport 38, the radiant light reflective mirror 41 and the radiation thermometer 42 are installed, and a periphery of the inlet flange 22 are spaced apart from a heating position of the wafers 6 by the heating coil 28 and the radiant heat is blocked by the insulating plate 33, the temperature of the inlet flange 22 and the periphery of the inlet flange 22 is decreased to about 200° C. to 300° C., which is substantially lower than the heat resistant temperature of quartz (1200° C.), and thus, damage to the radiant light reflective mirror 41 and the radiant thermometer 42 due to the heat can be prevented.

In addition, since the viewport 38 is installed at the inlet flange 22 and the radiant light 30 emitted from the temperature measurement chip 24 passes through the viewport 38 to be reflected by the radiant light reflective mirror 41 to enter the radiation thermometer 42, there is no need to punch the hole in the insulating material 26 to measure the temperature of the cylindrical heat generating material 23, the temperature distribution in the reaction chamber 32 can be maintained well, and the damage to the reaction tube 21 or the insulating casing 27 heated by the radiant heat from the hole to the heat resistant temperature of quartz (1200° C.) or higher can be prevented.

In addition, since the radiant light 30 is measured by the radiant thermometer 42 at a position below the lower end of the reaction tube 21, the radiant light 30 merely passes through the viewport 38, and thus, refraction of the radiant light 30 can be suppressed to stably measure and control the temperature, without passing the quartz of both the insulating casing 27 and the reaction tube 21.

Further, since the radiant light reflective mirror 41 for reflecting the radiant light 30 is installed to remove necessity of directly detecting the radiant light 30 using the radiation thermometer 42 and an installation place of the radiation thermometer 42 can be freely selected, the temperature control can be easily applied even when the radiation thermometer 42 cannot be easily installed at a position opposite to the temperature measurement chip 24.

Furthermore, since the viewport 38 is installed outside of the cylindrical heat generating material 23, i.e., outside the reaction chamber 32, and the space between the cylindrical heat generating material 23 at which the viewport 38 is installed and the insulating material 26 is purged by the purge gas, the process gas contacts the viewport 38, and deterioration in transparency of the viewport 38 due to sticking of a byproduct to the viewport 38 can be prevented, and reliability and reproduction of the measurement value by the radiation thermometer 42 can be remarkably improved.

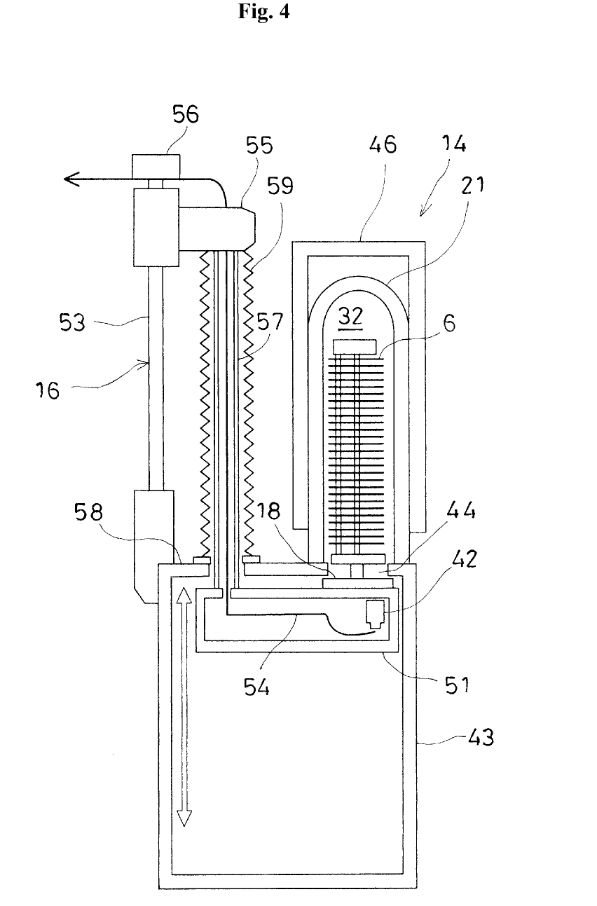

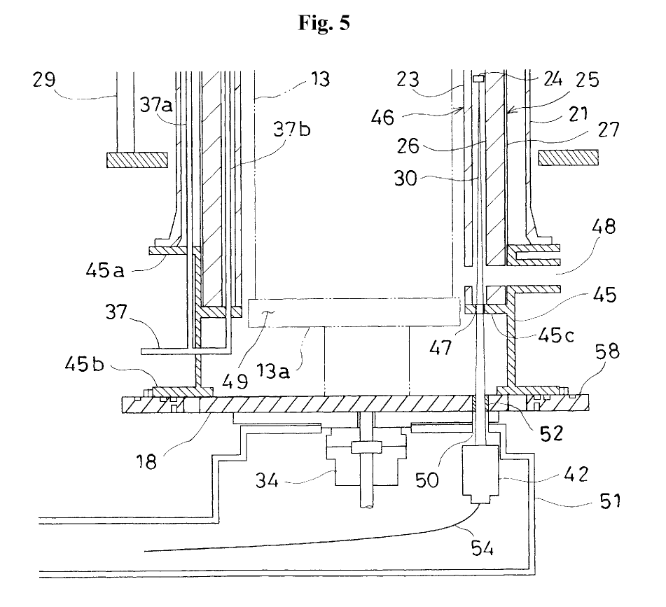

Next, the second embodiment of the present invention will be described with reference to FIGS. 4 and 5. In FIGS. 4 and 5, like reference numerals refer to like elements in FIGS. 1 through 3, and detailed description thereof will not be repeated.

FIG. 4 shows the processing furnace 14 and a periphery thereof, and FIG. 5 shows an enlarged view of the reaction chamber 32. The processing furnace 14 is vertically installed on a preliminary chamber 43 which is hermetically sealed, the preliminary chamber 43 and the process furnace 14 are concentric with a furnace port 44, a heating mechanism 46 including the cylindrical heat generating material 23, the insulating part 25 and the heating coil 28 (see FIG. 2) is installed at the furnace port 44, and the temperature measurement chip 24 having a rectangular shape and formed of the same material as the cylindrical heat generating material 23 protrudes from an outer circumference of the cylindrical heat generating material 23.

An inlet flange 45 is vertically installed at the preliminary chamber 43 to be concentric with the furnace port 44. The inlet flange 45 includes an upper flange 45a and a lower flange 45b extending from upper and lower ends thereof in an outer circumferential direction, and an intermediate flange 45c extending from a center part thereof in an inner circumferential direction.

The cylindrical heat generating material 23 and the insulating part 25 are vertically installed at the intermediate flange 45c, and a radiant light transmission hole 47 is punched at a position between the cylindrical heat generating material 23 and the insulating part 25 and opposite to the temperature measurement chip 24.

In addition, an exhaust port 48 is formed adjacent to the radiant light transmission hole 47 and on the intermediate flange 45c, and a hole is punched in the cylindrical heat generating material 23 and the insulating part 25 to be in communication with the exhaust port 48.

Further, an opening 49 is defined by the intermediate flange 45c, and the opening 49 is closed by a bottom plate 13a of the boat 13 to a substantial vacuum level when the boat 13 is loaded.

Furthermore, the first purge gas supply nozzle 37a for introducing the purge gas into the space between the reaction tube 21 and the insulating casing 27 is installed through the upper flange 45a of the inlet flange 45, and the second purge gas supply nozzle 37b for introducing the purge gas into the space between the cylindrical heat generating material 23 and the insulating material 26 horizontally is installed to pass through the inlet flange 45, vertically bend in the reaction chamber 32, and pass through the intermediate flange 45c.

A elevating part 51 is disposed under the furnace port 44, a seal cap 18 is installed at an upper surface of the elevating part 51 to hermetically seal the furnace port 44, a hole is punched in the seal cap 18 at a position opposite to the radiant light transmission hole 47, and the hole is filled with quartz to form a viewport 52.

The elevating part 51 has a hermetic hollow structure, in which a boat rotation mechanism 34 is installed, a radiation thermometer 42 is installed as a temperature detection unit at a position opposite to the viewport 52, a fiber cable 54 is connected to the radiation thermometer 42, and the fiber cable 54 is connected to a temperature control unit (not shown) through an inside of the elevating part 51 and a lift shaft 56, which will be described later. In addition, a hole 50 is punched in an upper surface of the elevating part 51 at a position opposite to the viewport 52, and the hole 50 is configured not to block the radiant light 30 passing through the viewport 52.

Further, a boat elevator 16 is installed at a side part of the preliminary chamber 43. The boat elevator 16 includes a ball screw 53, and a lift frame 55 is rotatably threadedly engaged with the ball screw 53. A lift motor 56 is coupled to an upper end of the ball screw 53, and the ball screw 53 is rotated by driving the lift motor 56.

A hollow lift shaft 57 is vertically installed at the lift frame 55, and a connection part of the lift frame 55 and the lift shaft 57 is hermetically sealed. The lift shaft 57 is installed to be raised and lowered with the lift frame 55, the lift shaft 57 passes loosely through a ceiling plate 58 of the preliminary chamber 43, and a through-hole of the ceiling plate 58 is configured not to contact the lift shaft 57.

A bellows 59 having flexibility is installed between the preliminary chamber 43 and the lift frame 55 to surround the lift shaft 57. The bellows 59 is configured to hermetically maintain the preliminary chamber 43 and not to contact the lift shaft 57 when the bellows 59 is expanded and contracted.

When the film forming process is performed, first, the boat 13 into which a predetermined number of wafers 6 and the insulating plate 33 (see FIG. 2) are charged is loaded into the reaction chamber 32, a process gas is introduced into the reaction chamber 32, a high frequency current is applied to the heating coil 28, and a purge gas is introduced into a space between the reaction tube 21 and the insulating casing 27 and a space between the cylindrical heat generating material 23 and the insulating material 26.

As the cylindrical heat generating material 23 is heated, the boat 13 and the wafers 6 are heated, and SiC crystalline films are formed on the wafers 6. When the film forming process ends, the process gas and the purge gas are exhausted, and the boat 13 is unloaded from the reaction chamber 32.

In addition, a purge gas exhaust port may be formed in the upper flange 45a of the inlet flange 45 similar to the purge gas exhaust port 40 of the first embodiment (see FIG. 2), or the hole punched in the cylindrical heat generating material 23 and the insulating part 25 may be used as the purge gas exhaust port in order to communicate the reaction chamber 32 with the exhaust port 48 when the exhaust port 48 is installed.

During the process, the radiant light 30 emitted from the temperature measurement chip 24 passes through the radiant light transmission hole 47 and the viewport 52 and enters the radiation thermometer 42. As the radiation thermometer 42 detects to always measure the temperature of the cylindrical heat generating material 23 by detecting the radiant light 30, the measurement result is fed back to the temperature control unit (not shown) via the fiber cable 54, and the temperature control unit applies the radio frequency current to the heating coil 28 based on the fed-back measurement result, controlling heating of the cylindrical heat generating material 23.

In addition, the insulating part 25 blocks the radiant heat from the heated cylindrical heat generating material 23 and suppresses heat transfer to the reaction tube 21 and the outer wall 31 (see FIG. 2), and the insulating plate 33 (see FIG. 2) blocks the radiant heat from the wafers 6 or the boat 13 and suppresses heat transfer to a lower part of the reaction chamber 32 such as the inlet flange 45, the seal cap 18 and the viewport 52.

Since the seal cap 18 at which the viewport 52 is installed is spaced apart from a heating position of the wafers 6 by the heating coil 28 and the radiant heat is blocked by the insulating plate 33 (see FIG. 2), a temperature of the viewport 52 is decreased to about 200° C. to 300° C. which is substantially lower than a heat resistant temperature of quartz (1200° C.), and thus, damage to the viewport 52 due to the heat can be prevented.

In addition, since the radiation thermometer 42 and the fiber cable 54 connected to the radiation thermometer 42 are installed in the elevating part 51 under the seal cap 18 to block the heat in the reaction chamber 32 using the seal cap 18 and the elevating part 51, similar to the fiber cable 54 connected to the radiation thermometer 42, temperature measurement by the radiation thermometer 42 becomes possible even when the heat resistant temperature is low.

Further, since the viewport 52 is installed at the seal cap 18 and the radiant light 30 emitted from the temperature measurement chip 24 passes through the viewport 52 and enters the radiation thermometer 42, there is no need to punch the hole in the insulating material 26 in order to measure the temperature of the cylindrical heat generating material 23, temperature distribution in the reaction chamber 32 can be maintained well, and increase in temperature of the reaction tube 21 or the insulating casing 27 to the heat resistant temperature of quartz (1200° C.) or higher by the radiant heat from the hole for temperature measurement and damage due to the heat can be prevented.

Furthermore, since the intermediate flange 45c at which the cylindrical heat generating material 23 and the insulating part 25 are vertically installed is provided and the radiant light transmission hole 47 is punched in the intermediate flange 45c only, the radiant light 30 passes through the quartz of the viewport 52 only to remove necessity of transmitting the quartz of both the insulating casing 27 and the reaction tube 21, refraction, etc. of the radiant light 30 is suppressed, and stable temperature measurement and temperature control become possible.

In addition, since the exhaust port 48 is installed adjacent to the radiant light transmission hole 47 and over the intermediate flange 45c and the opening 49 is substantially closed by the bottom plate 13a of the boat 13 during the film forming process, a space under the intermediate flange 45c becomes a substantial vacuum state, and the process gas does not contact the viewport 52. Accordingly, since formation of the SiC film on the viewport 52 is suppressed, deterioration in transparency of the viewport 52 due to the SiC film is prevented, and the measurement result does not vary as time elapses, reliability and reproduction of the measurement value of the radiation thermometer 42 can be remarkably improved.

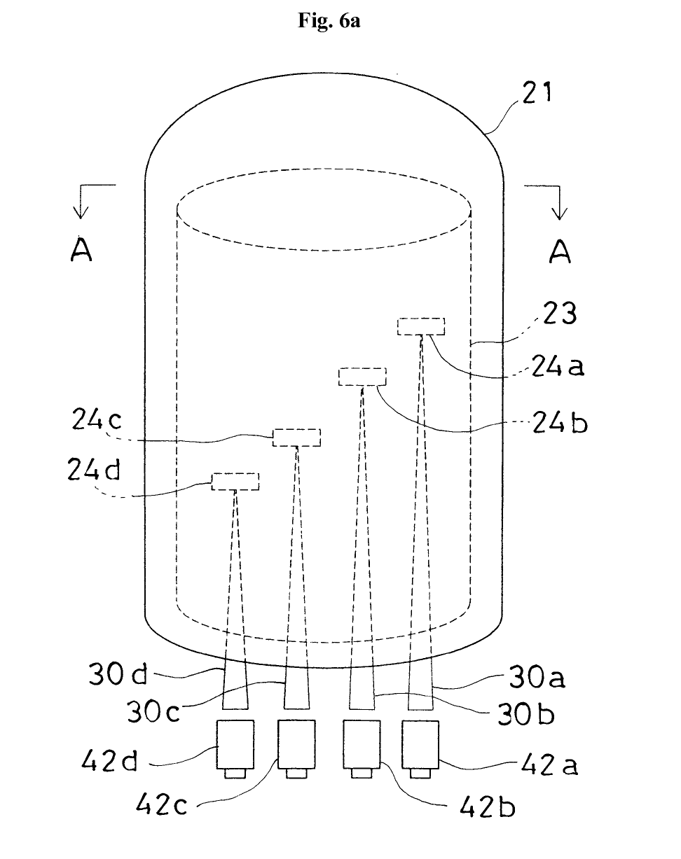

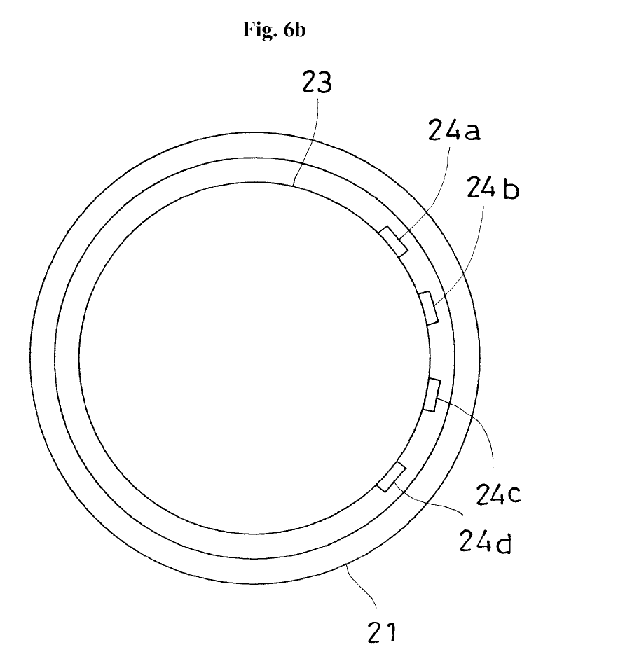

Hereinafter, the third embodiment of the present invention will be described with reference to FIG. 6. In FIG. 6, like reference numerals refer to like elements in FIGS. 1 through 3, and detailed description will not be repeated.

While only one temperature measurement chip 24 protrudes from the outer circumference of the cylindrical heat generating material 23 to detect the radiant light 30 emitted from the temperature measurement chip 24 using the radiation thermometer 42 to measure the temperature of the cylindrical heat generating material 23 according to the first embodiment and the second embodiment, a plurality of temperature measurement chips 24 are installed at different positions to measure the temperature of the temperature measurement chips 24 to measure temperature distribution of the cylindrical heat generating material 23 according to the third embodiment.

The plurality of temperature measurement chips 24 (four in the drawing) having a rectangular shape and made of the same material as the cylindrical heat generating material 23 protrude from an outer circumference of the cylindrical heat generating material 23. The temperature measurement chips 24a through 24d are installed at different heights and different positions in a circumferential direction of the cylindrical heat generating material 23, not overlapping in a vertical direction thereof

As temperature detection unit, radiation thermometers 42a through 42d are installed at the temperature measurement chips 24a through 24d at positions opposite to a viewport (not shown) to detect radiation light 30a through 30d emitted from the temperature measurement chips 24a through 24d, measuring the temperature of the cylindrical heat generating material 23.

When the film forming process is performed, a radio frequency current is applied to a heating coil 28 (see FIG. 2), and the cylindrical heat generating material 23 is heated. During the film forming process, the temperatures of the cylindrical heat generating material 23 are always measured by the radiation thermometers 42a through 42d via the temperature measurement chips 24a through 24d, and the radiation thermometers 42a through 42d feed the measurement results back to the temperature control unit (not shown), and the temperature control unit regulates the radio frequency current applied to the heating coil 28 according to the fed back measurement results.

Here, since the temperature measurement chips 24a through 24d are installed at different heights and the temperatures of the cylindrical heat generating material 23 measured by the radiation thermometers 42a through 42d are the temperatures of the heights at which the temperature measurement chips 24a through 24d are installed, the measurement results of the radiation thermometers 42a through 42d are collected to obtain temperature distribution of the cylindrical heat generating material 23 in a height direction thereof, and the radio frequency current applied to the heating coil 28 is regulated based on the obtained temperature distribution, enabling more precise control of the temperature of the cylindrical heat generating material 23.

In addition, in the third embodiment, while the radiant light 30a through 30d emitted from the temperature measurement chips 24a through 24d is configured to directly enter the radiation thermometers 42a through 42d similar to the second embodiment, radiant light reflective mirrors may be installed at positions opposite to the temperature measurement chips 24a through 24d, respectively, so that the radiant light 30a through 30d reflected by the radiant light reflective mirrors enters the radiation thermometers 42a through 42d similar to the first embodiment.

Further, while the four temperature measurement chips 24a through 24d and the radiation thermometers 42a through 42d are installed according to the third embodiment, the numbers of the temperature measurement chips 24 and the radiation thermometers 42 are not limited to 4, but a large number of the temperature measurement chips 24 and the radiation thermometers 42 may be installed to obtain more specified temperature distribution of the cylindrical heat generating material 23 and enable more precise heating control.

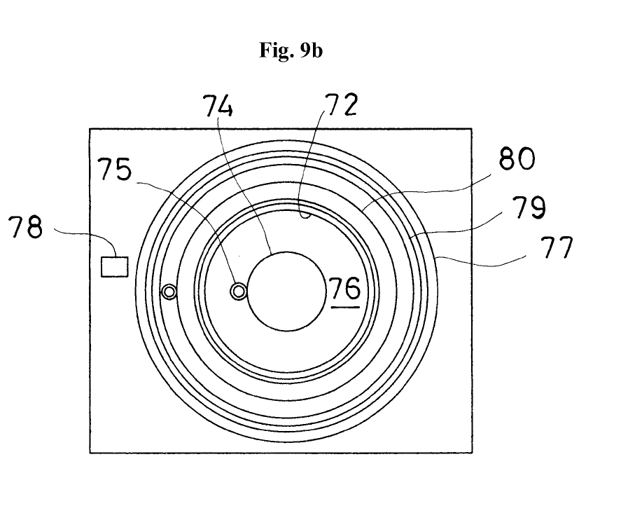

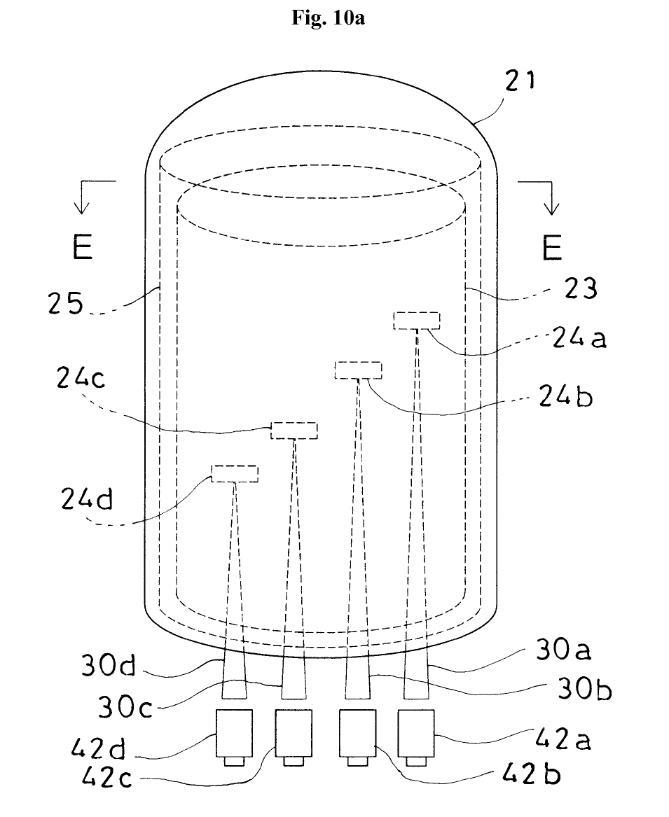

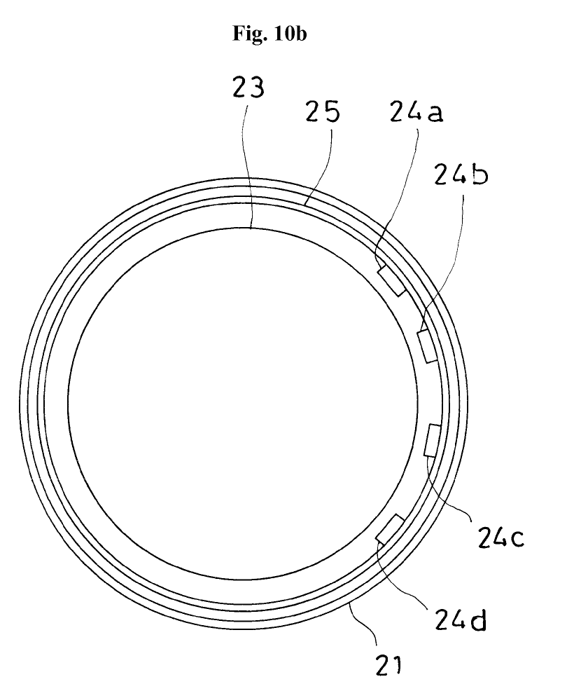

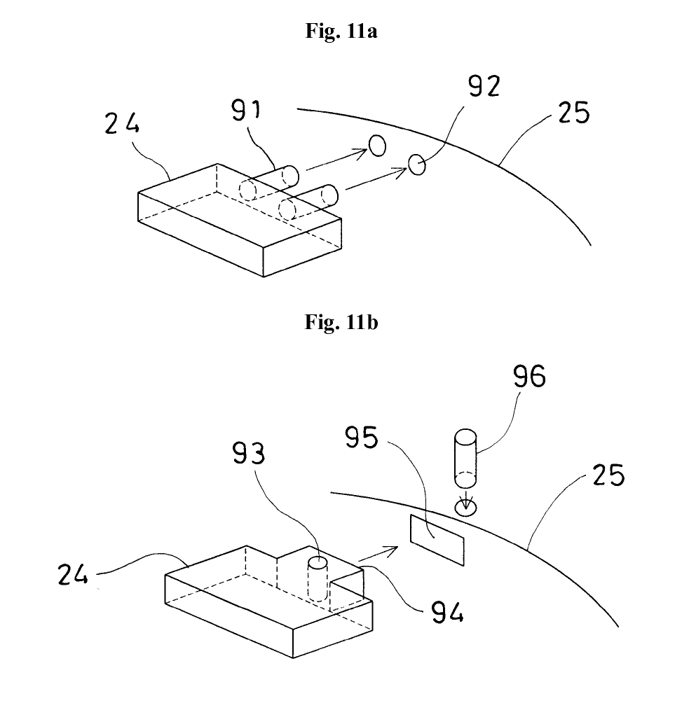

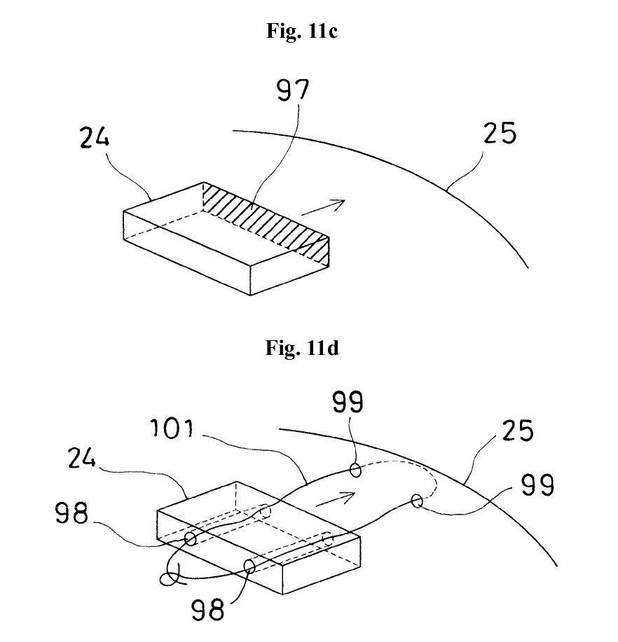

Hereinafter, the fourth embodiment of the present invention will be described with reference to FIGS. 10 and 11. In FIGS. 10 and 11, like reference numerals refer to like elements in FIG. 6, and detailed description thereof will not be repeated.

While the temperature measurement chips 24a through 24d having a rectangular shape and made of the same material as the cylindrical heat generating material 23 are installed at the outer circumference of the cylindrical heat generating material 23 according to the third embodiment, the temperature measurement chips 24a through 24d according to the fourth embodiment may be installed at an inner circumference of the insulating part 25 at different heights and different positions in the circumferential direction, not overlapping the temperature measurement chips 24a through 24d in the vertical direction and not contacting the cylindrical heat generating material 23.

A method of installing the temperature measurement chips 24a through 24d at the insulating part 25 may include, as shown in FIG. 11A, installing a projection 91 at the temperature measurement chip 24, punching a hole 92 through which the projection 91 can be inserted in the insulating part 25, and inserting the projection 91 into the holes 92 to install the temperature measurement chip 24 at the insulating part 25. The method may include, as shown in FIG. 11B, forming a protrusion 94 in which a hole 93 vertically passing through the temperature measurement chip 24 is punched, punching a hole 95 through which the protrusion 94 can pass in the insulating part 25, and inserting a pin 96 into the hole 93 to fix the temperature measurement chip 24 with the protrusion 94 inserted into the hole 95.

In addition, the method may include, as shown in FIG. 11C, applying a heat resistant adhesive 97 such as a carbon adhesive to an end surface of the temperature measurement chip 24, and adhering the temperature measurement chip 24 to an inner circumference of the insulating part 25 using the adhesive 97. The method may include, as shown in FIG. 11D, punching holes 98 in the temperature measurement chip 24, punching holes 99 in the insulating part 25, inserting a carbon fiber 101 through the holes 98 and the holes 99, and binding the temperature measurement chip 24 to the insulating part 25 using the carbon fiber 101.

In the first through third embodiments, since the temperature measurement chip 24 is directly installed at the cylindrical heat generating material 23 and a cross-sectional area of the cylindrical heat generating material 23 at which the temperature measurement chip 24 is installed is increased, a resistance may be decreased and a heating temperature may be lowered. Meanwhile, in the fourth embodiment, since the temperature measurement chip 24 is installed at the inner circumference of the insulating part 25 and the temperature measurement chip 24 is configured not to contact the cylindrical heat generating material 23, the cross-sectional area of the cylindrical heat generating material 23 is uniform throughout an entire length thereof, and stability of heating by the cylindrical heat generating material 23 can be maintained.

In addition, since the temperature measurement chip 24 is installed at the inner circumference of the insulating part 25, the temperature measurement chip 24 and the cylindrical heat generating material 23 can be equally heated, rather than insulating the temperature measurement chip 24 by the insulating part 25, and precise temperature measurement by the radiation thermometer 42 becomes possible.

Further, similar to the third embodiment, the radiant light reflective mirrors may be installed at positions opposite to the temperature measurement chips 24a through 24d such that the radiant light 30a through 30d reflected by the radiant light reflective mirrors enters the radiation thermometers 42a through 42d. Of course, a larger number of the temperature measurement chips 24 and the radiation thermometers 42 may be installed to obtain more specific temperature distribution.

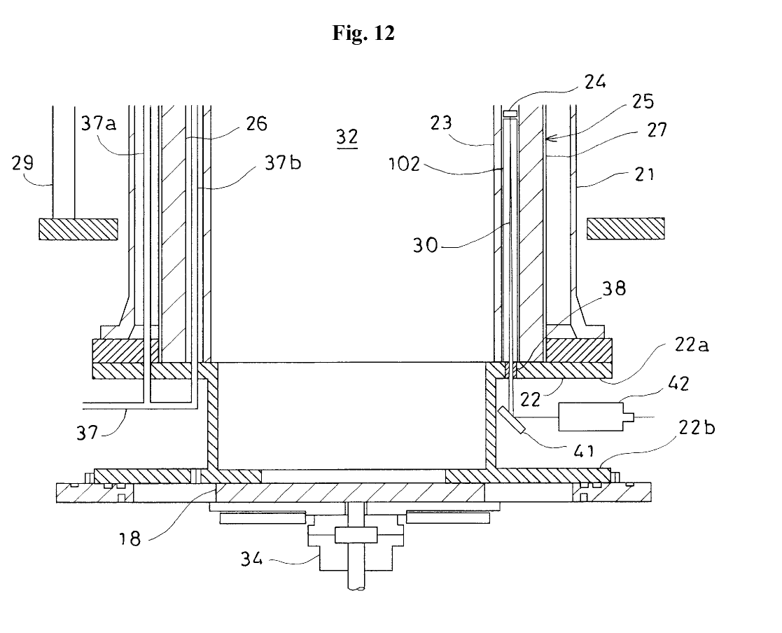

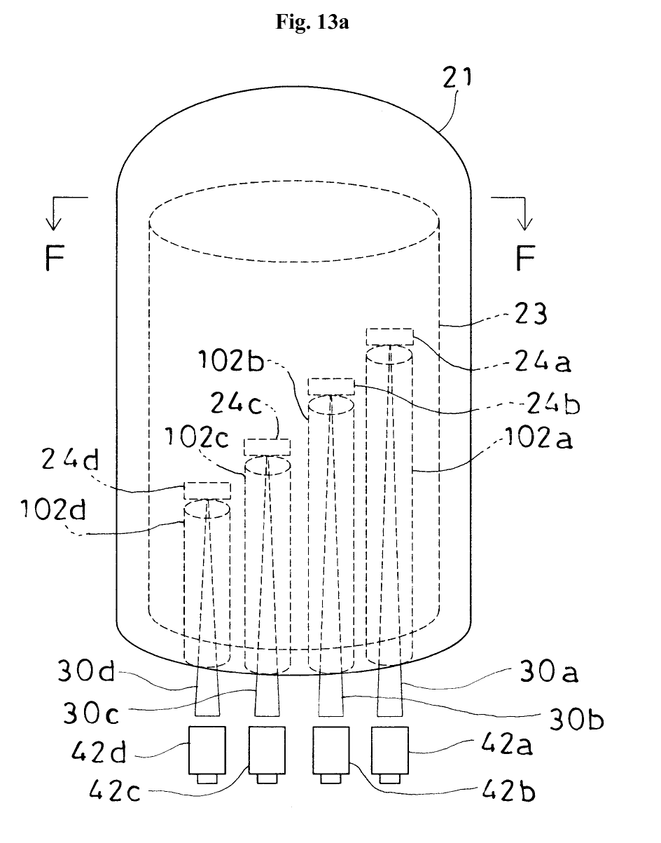

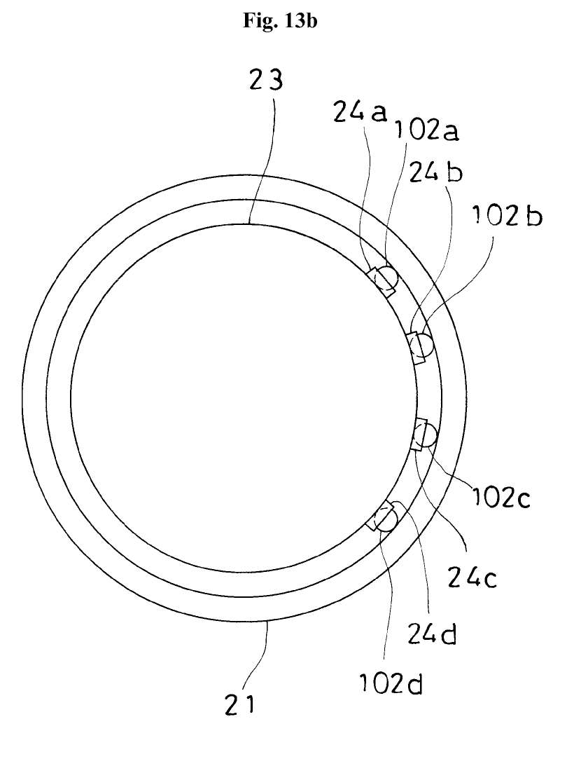

Hereinafter, the fifth embodiment of the present invention will be described with reference to FIGS. 12 and 13. In FIGS. 12 and 13, like reference numerals refer to like elements in FIG. 3, and detailed description will not be repeated.

In the fifth embodiment, a protection tube 102 formed of, for example, carbon or sapphire, is installed in a space between the temperature measurement chip 24 and the viewport 38.

The protection tube 102 has a cylindrical shape, and the radiant light 30 emitted from the temperature measurement chip 24 passes through the protection tube 102. In addition, an inner diameter of the protection tube 102 is larger (for example, 30 to 50 mm) than a spot diameter (for example, 10 to 20 mm) of the radiant light 30 measured by the radiation thermometer 42, and an upper end of the protection tube 102 and the temperature measurement chip 24 are substantially close to each other and a lower end of the protection tube 102 and the viewport 38 are also substantially close to each other.

In the fifth embodiment, since the protection tube 102, through which the radiant light 30 passes, having the inner diameter larger than the spot diameter of the radiant light 30 not to block the radiant light 30 is installed in the space between the temperature measurement chip 24 and the viewport 38, intrusion of the process gas supplied from the process gas supply nozzle 35 (see FIG. 2), the purge gas supplied from the purge gas supply nozzle 37, fine particles regenerated through a reaction with a gas phase during the film forming process or fine particles flaked from the process gas supply nozzle 35, the purge gas supply nozzle 37, the reaction tube 21, etc., particles generated from the insulating material 26 into an optical path of the radiant light 30 emitted from the temperature measurement chip 24 can be prevented, and thus, blocking of the optical path of the radiant light 30 can be prevented.

Therefore, as the radiant light 30 is blocked and polarized by a disturbance such as the gas, fine particles and particles, a measurement error or an error in measurement temperature of the radiation thermometer 42 for measuring the radiant light 30 can be prevented, and stable temperature measurement and temperature control can be performed.

In addition, while the temperature measurement chip 24 is installed at the cylindrical heat generating material 23 according to the fifth embodiment, similar to the fourth embodiment, the temperature measurement chip 24 may be installed at the inner circumference of the insulating part 25, i.e., the inner circumference of the insulating material 26.

Further, when the plurality of temperature measurement chips 24 are installed, as shown in FIG. 13, protection tubes 102a through 102d may be installed between the temperature measurement chips 24a through 24d and the view ports 38 (not shown), respectively, such that the fifth embodiment may be applied to the third embodiment and the fourth embodiment.

Furthermore, when the protection tube passing through the radiant light transmission hole 47 (see FIG. 5) and coming in close contact with the temperature measurement chip 24 and the viewport 52 (see FIG. 5) is installed, the fifth embodiment may be applied to the second embodiment.

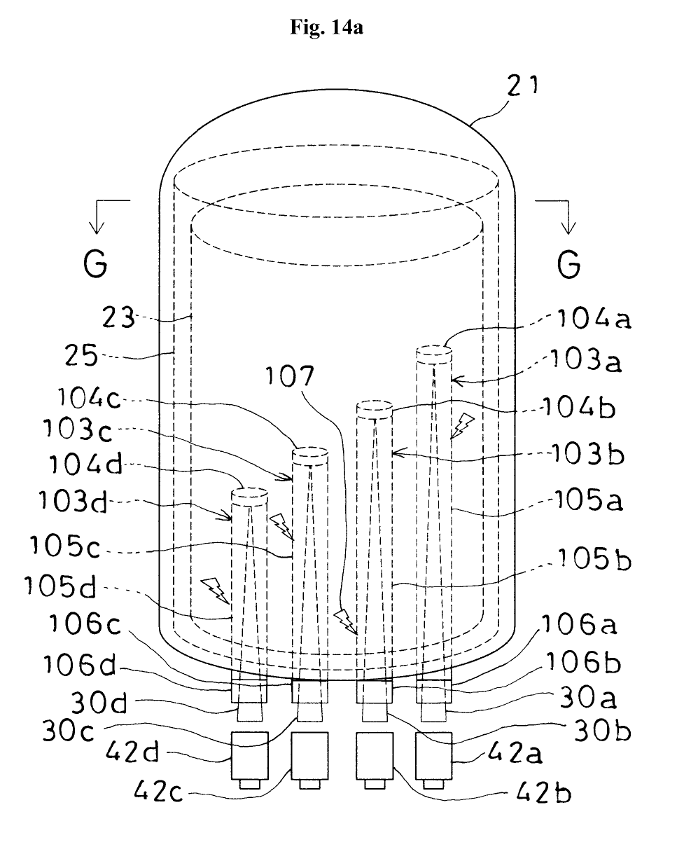

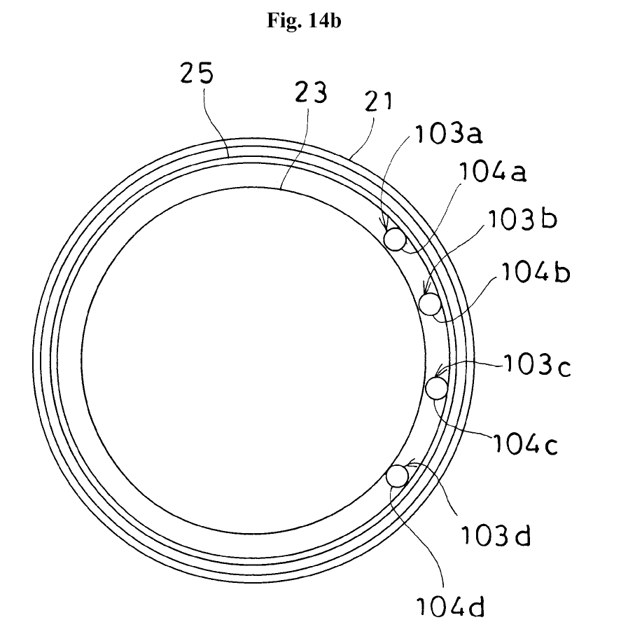

Hereinafter, the sixth embodiment of the present invention will be described with reference to FIG. 14. In FIG. 14, like reference numerals refer to like elements in FIG. 13, and detailed description thereof will not be repeated.

In the sixth embodiment, the temperature measurement chip 24 and the protection tube 102 of the fifth embodiment are integrated with each other to form a protection tube 103.

The protective tube 103 is a hollow tube having a tubular shape with a ceiling and made of a carbon material, and includes a temperature measurement part 104 as a temperature measurement chip installed at an apex part thereof, a protection part 105 installed at a hollow tube part thereof, and a viewport 106 formed of a quartz material installed at a lower end thereof.

In the protection tube 103, a predetermined number of protection tubes 103 having different heights, for example, four protection tubes 103a through 103d, are vertically installed in a space between the cylindrical heat generating material 23 and the insulating part 25 not to contact each other. The radiation thermometers 42a through 42d are installed at positions opposite to the temperature measurement parts 104a through 104d, respectively, with the viewports 106a through 106d interposed therebetween, and the radiant light 30a through 30d emitted from the temperature measurement parts 104a through 104d enters the radiation thermometers 42a through 42d, so that temperatures of the cylindrical heat generating material 23 can be measured at the heights at which the temperature measurement parts 104a through 104d are disposed.

In addition, inner diameters of protection parts 105a through 105d are larger than spot diameters of the radiant light 30a through 30d not to block the radiant light 30a through 30d entering the radiation thermometers 42a through 42d, and the protection parts 105a through 105d have such thicknesses that the protection parts 105a through 105d cannot be easily affected by the heat from the cylindrical heat generating material 23, and an insulation property that the heat of the temperature measurement parts 104a through 104d cannot be easily transferred.

As described above, in the sixth embodiment, since the protection tube 103 is configured so that the temperature measurement part 104, the protection part 105 and the viewport 106 are integrally formed with one another, in comparison with the fifth embodiment in which the optical path of the radiant light 30 is protected using the protection tube 102 (see FIG. 12) formed as a separate member, the optical path of the radiant light 30 between the temperature measurement part 104 and the viewport 106 can be completely closed.

Therefore, blocking and polarization of the radiant light 30 by a disturbance 107 such as a gas, fine particles and particles can be completely prevented, and stable temperature measurement and temperature control can be performed without a measurement error and an error in measurement temperature of the radiation thermometer 42 for measuring the radiant light 30.

In addition, since the protection tube 103 is vertically installed in a space between the cylindrical heat generating material 23 and the insulating part 25, i.e., the temperature measurement part 104 is disposed at a position spaced apart from the cylindrical heat generating material 23, a cross-sectional area in a height direction of the cylindrical heat generating material 23 is uniform throughout an entire length thereof, and stability of heating by the cylindrical heat generating material 23 can be maintained.

Further, since the temperature measurement part 104 and the protection part 105 are made of the same material, the protection tube 103 can be manufactured at a low cost.

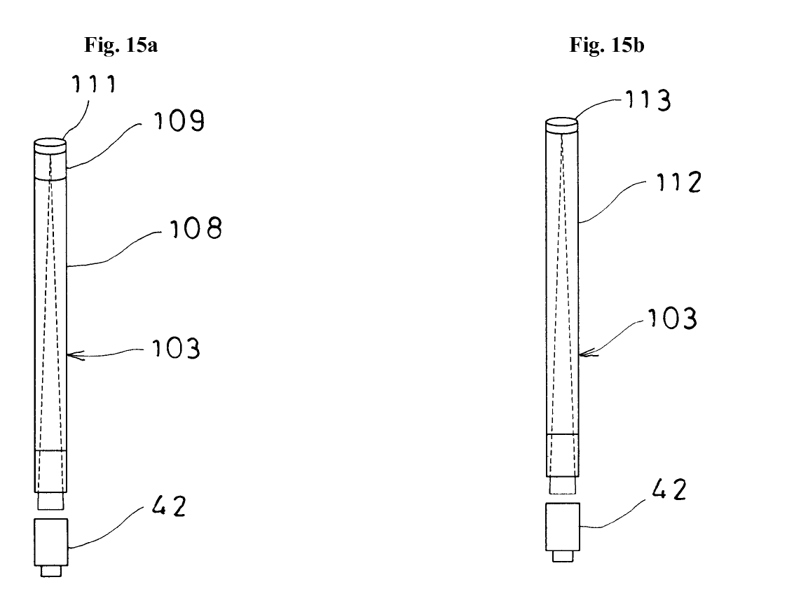

FIGS. 15A and 15B illustrate the modified examples of the sixth embodiment.

In FIG. 15A, the temperature measurement part 104 and the protection part 105 are separately formed from each other. An insulating part 109 formed of a carbon felt and having a cylindrical shape is continuously installed at an upper end of a protection part 108 formed of a carbon material and having a cylindrical shape, and an upper end of the insulating part 109 is closed by a temperature measurement part 111 formed of the same carbon material as the cylindrical heat generating material 23 (see FIG. 14) and having a circular disk shape.

In the above modified example, since the insulating part 109 is interposed between the temperature measurement part 111 and the protection part 108 so that the temperature measurement part 111 is not in direct contact with the protection part, heat of the heated temperature measurement part 111 is not transferred to the protection part 108, heat of the protection part 108 is not transferred to the temperature measurement part 111, and thus, the temperature of the cylindrical heat generating material 23 can be precisely measured at a height at which the temperature measurement part 111 is disposed.

In addition, in FIG. 15B, the temperature measurement part 104 and the protection part 105 are formed separately from each other, and an upper end of a protection part 112 formed of a carbon felt and having a cylindrical shape is closed by a temperature measurement part 113 formed of the same carbon material as the cylindrical heat generating material 23 and having a circular disk shape.

In the above modified example, since heat transfer from the temperature measurement part 113 to the protection part 122 and from the protection part 112 to the temperature measurement part 113 can be prevented similar to the case of FIG. 15A, the temperature of the cylindrical heat generating material 23 can be precisely measured, and the number of components is reduced in comparison with the case of FIG. 15A, thus facilitating ease of manufacture.

In addition, in the sixth embodiment and the modified examples thereof, while the protection parts 105a through 105d have a tubular shape with a ceiling or a cylindrical shape are configured to measure the temperature of the cylindrical heat generating material 23 using the temperature measurement parts 104a through 104d having a circular plate shape, when the inner diameter of the protection tubes 103a through 103d is larger than the spot diameter of the radiant light 30a through 30d entering the radiation thermometers 42a through 42d, the protection tubes may have an arbitrary shape such as a rectangular temperature measurement part and a square post shape of protection tube.

Further, in the sixth embodiment, while the radiant light 30a through 30d emitted from the temperature measurement parts 104a through 104d directly enters the radiation thermometers 42a through 42d, radiant light reflective mirrors 41 may be installed at positions opposite to the temperature measurement parts 104a through 104d, respectively, such that the radiant light 30a through 30d reflected by the radiant light reflective mirrors 41 enters the radiation thermometers 42a through 42d, or the protection tube 103 may be configured such that the temperature measurement parts 104a through 104d, the protection parts 105a through 105d, the viewports 106a through 106d and the radiant light reflective mirrors 41 are integrally formed with each other.

Furthermore, in the sixth embodiment, while the case that the four protection tubes 103a through 103d are vertically installed is exemplarily described, the number of the protection tubes 103a through 103d is not limited to four but a larger number of protection tubes 103 may be vertically installed to obtain more specific temperature distribution of the cylindrical heat generating material 23 and enable more precise heating control.

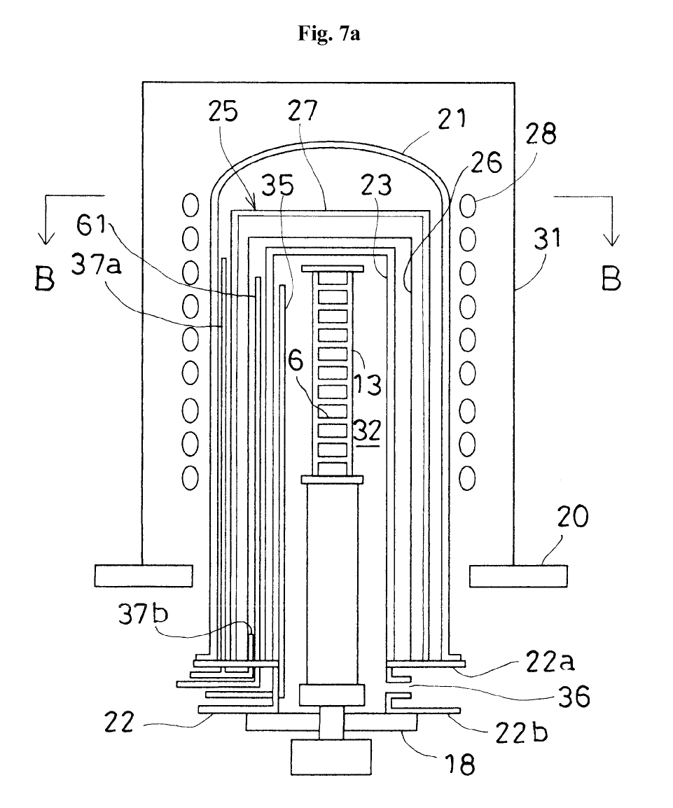

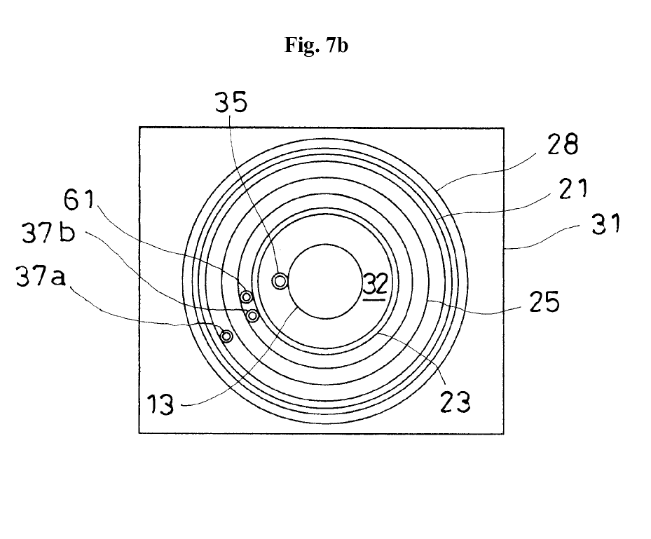

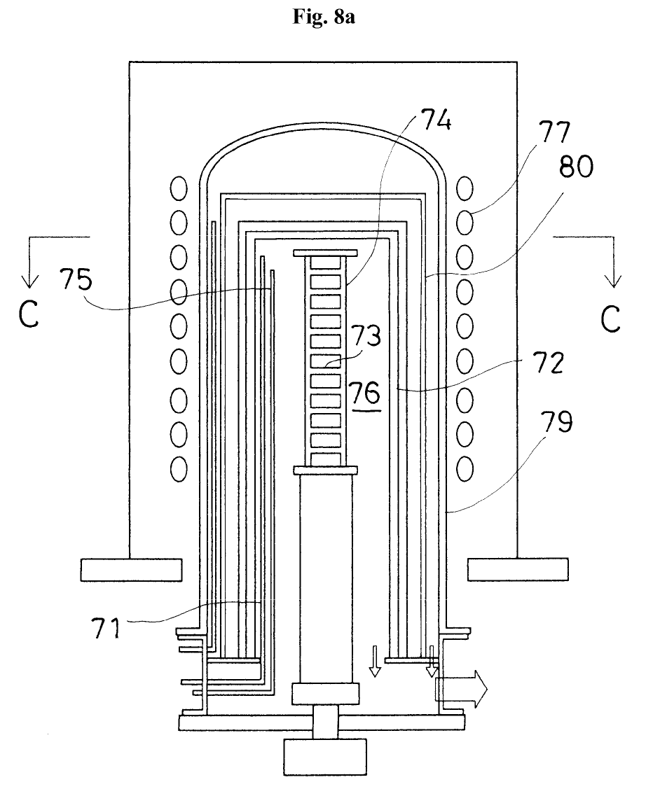

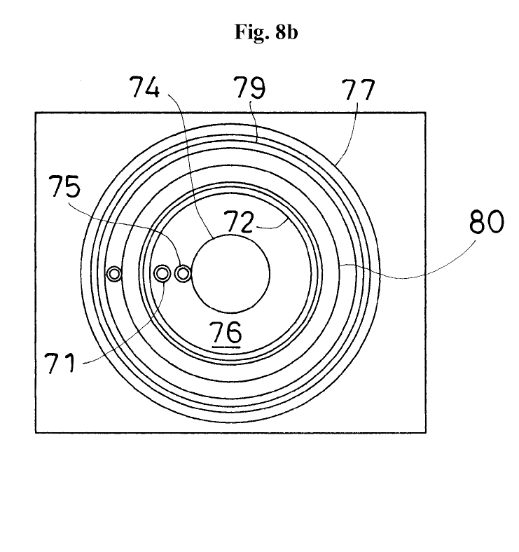

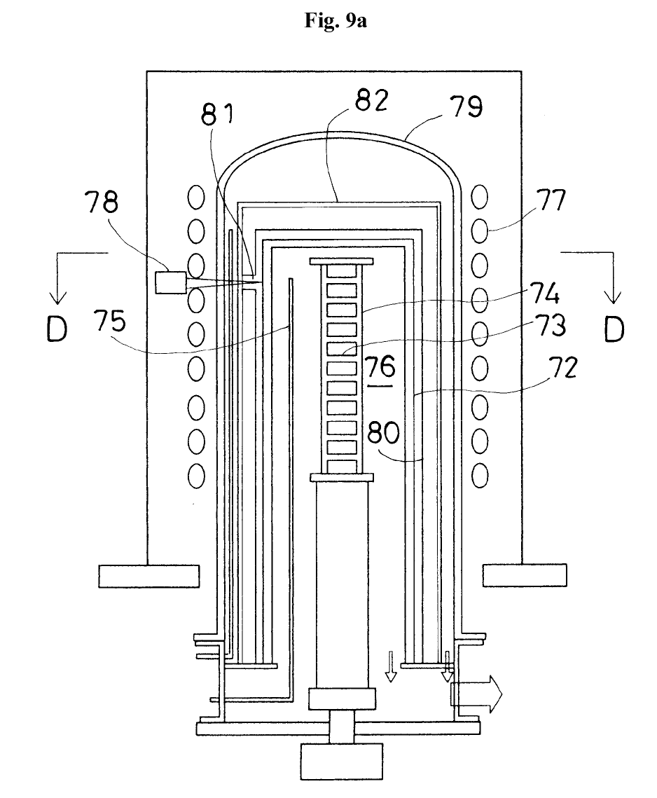

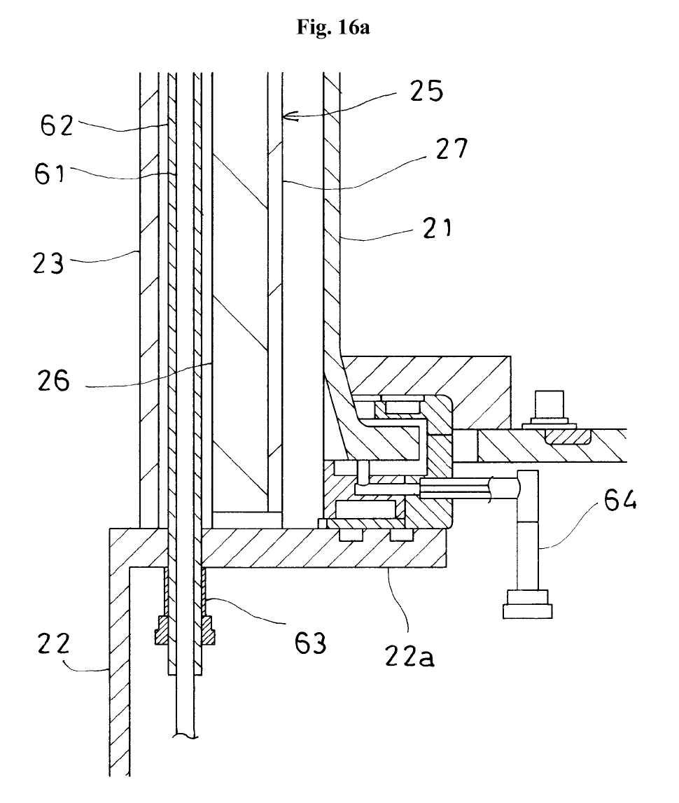

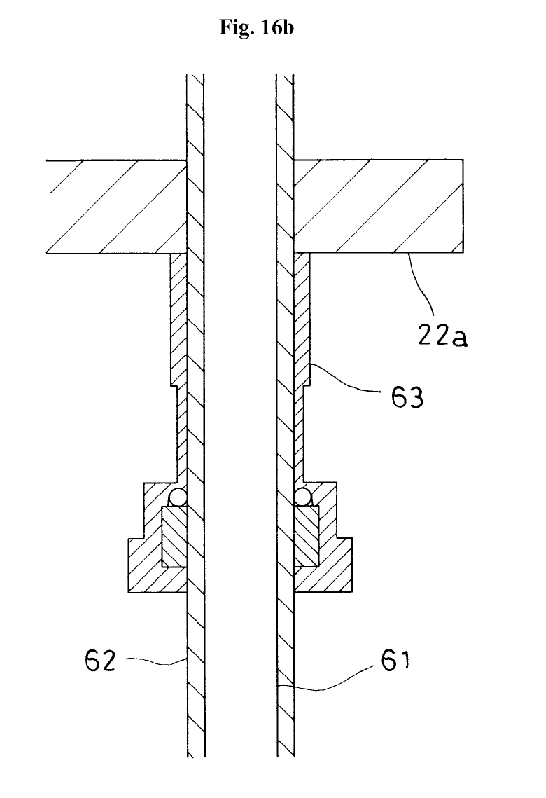

Hereinafter, the seventh embodiment of the present invention will be described with reference to FIGS. 7 and 16. In FIGS. 7 and 16, like reference numerals refer to like elements in FIGS. 1 through 3, and detailed description thereof will not be repeated.

In the seventh embodiment, unlike the first through sixth embodiments, a control TC 61 is used as a temperature detection unit.

An inlet flange 22 having upper and lower flanges 22a and 22b formed at upper and lower ends thereof is hermetically installed at a lower end of a reaction tube 21 for processing a wafer 6, a gas exhaust port 36 is installed at the inlet flange 22, and a tubular exhaust space is formed inside the inlet flange 22. A cylindrical heat generating material 23 is vertically installed at the inlet flange 22 in the reaction tube 21, and an insulating part 25 in which an insulating material 26 installed at an inner layer and an insulating casing 27 installed at an outer layer are integrally formed with each other is vertically installed between the cylindrical heat generating material 23 and the reaction tube 21. In addition, an inner diameter of the inlet flange 22 is smaller than an inner diameter of the cylindrical heat generating material 23.

A heating coil 28 is installed outside the reaction tube 21, and the heating coil 28 is supported by a support post (not shown) and covered by an outer wall 31.

In addition, a reaction chamber 32 is partitioned by at least the cylindrical heat generating material 23, the inlet flange 22 and a seal cap 18.

A process gas supply nozzle 35 for supplying a process gas into the reaction chamber 32 horizontally passes through the inlet flange 22, and is vertically installed along an inner wall of the cylindrical heat generating material 23.

Further, a purge gas supply nozzle 37 for supplying a purge gas into a space between the reaction tube 21 and the insulating casing 27 and a space between the cylindrical heat generating material 23 and the insulating material 26 horizontally extends close to the inlet flange 22 and is split into two lines at a space between the upper and lower flanges 22a and 22b. In the two lines of the purge gas supply nozzle 37, a first purge gas supply nozzle 37a is vertically bent upward as one line, passes through the upper flange 22a, and extends to a space between the reaction tube 21 and the insulating casing 27. A second purge gas supply nozzle 37b is vertically bent upward as the other line at a position nearer to the inlet flange 22 than the first purge gas supply nozzle 37a, passes through the upper flange 22a, and extends to a space between the cylindrical heat generating material 23 and the insulating material 26.

Furthermore, a protection tube 62 passes through the upper flange 22 and is installed at the same space as the second purge gas supply nozzle 37b, i.e., the space between the cylindrical heat generating material 23 and the insulating material 26, an upper end of the protection tube 62 is closed, a lower end of the protection tube 62 has a tubular shape with a ceiling, which is open at a space between the upper flange 22a and the lower flange 22b, and a portion of the protection tube 62 passing through the upper flange 22a is sealed from a lower side of the upper flange 22a by an ultra-Torr 63 (a vacuum conjunction part) through which the protection tube 62 is inserted. In addition, reference numeral 64 of FIG. 16 designates a cooling system for supplying cooling water to a flange of a lower end of the reaction tube 21 and a seal surface of the upper flange 22a.

The control TC 61 horizontally extends adjacent to the inlet flange 22, is vertically bent upward at the space between the upper flange 22a and the lower flange 22b, and is inserted from a lower end of the protection tube 62 into the protection tube 62. In the space between the cylindrical heat generating material 23 and the insulating material 26, the control TC 61 is covered and protected by the protection tube 62. In addition, the protection tube 62 may be made of sapphire that has high resistance and is not easily inducted in order to avoid an operation error and a detection error of the control TC 61 due to induction heating.

During the film forming process, the boat 13 is loaded into the reaction chamber 32, a process gas is supplied into the reaction chamber 32 from the process gas supply nozzle 35, and a radio frequency current is applied to the heating coil 28, heating the cylindrical heat generating material 24.

In addition, during the above process, the purge gas is supplied from the first purge gas supply nozzle 37a and the second purge gas supply nozzle 37b into the space between the reaction tube 21 and the insulating casing 27 and the space between the cylindrical heat generating material 23 and the insulating material 26.

When the film forming process ends, the process gas in the reaction chamber 32 or the purge gas in the space between the reaction tube 21 and the insulating casing 27 and the space between the cylindrical heat generating material 23 and the insulating material 26 is exhausted by an exhaust device (not shown) via the gas exhaust port 36, and the boat 13 is unloaded from the reaction chamber 32.

During the process, the temperature of the cylindrical heat generating material 23 is always measured by the control TC 61, the measurement result is fed back to a temperature control unit (not shown), and the temperature control unit controls the radio frequency current applied to the heating coil 28 based on the fed back measurement result.

As described above, the control TC 61 is installed as the temperature detection unit at the space between the cylindrical heat generating material 23 and the insulating material 26, i.e., outside the reaction chamber 32. Since the protection tube 62 covering the control TC 61 is etched but the wafer 6 is not contaminated by an element from the etched protection tube 62 and variation in heat transfer rate to the control TC 61 due to the formed SiC film can be suppressed because a SiC film is not formed on the protection tube 62, variation in measurement value according to passage of time can be prevented, and reliability and reproduction of the measurement value of the control TC 61 can be improved.

In addition, as the purge gas is supplied into the space between the cylindrical heat generating material 23 and the insulating material 26, intrusion of the process gas, etc. from a gap between a lower end of the cylindrical heat generating material 23 and an upper surface of the upper flange 22a can be prevented, contact of the process gas with the protection tube 62 can be further suppressed, and reliability and reproduction of the measurement value of the control TC 61 can be improved.

Further, since the protection tube 62 is made of sapphire which is not easily induction-heated, the protection tube 62 is not induction-heated by the heating coil 28, and an operation error and a detection error of the control TC 61 due to induction heating of the protection tube 62 can be prevented.

Furthermore, since the protection tube 62 passes through the upper flange 22a from a lower side thereof such that a lower end of the protection tube 62 is disposed between the upper flange 22a and the lower flange 22b, the protection tube 62 may have a rod shape without a bent portion and thus the protection tube 62 may also be formed of a material that is not easily processed, and thus the protection tube 62 may be formed of various materials.

[Supplementary Notes]

In addition, the present invention includes the following aspects.

(Supplementary Note 1)

A heat treatment apparatus for growing single crystalline films or polycrystalline films on a plurality of substrates, the heat treatment apparatus including: a boat configured to hold the plurality of substrates; a cylindrical heat generating material installed to surround the boat and constituting a reaction chamber; a reaction tube installed to surround the cylindrical heat generating material; a cylindrical insulating part installed between the cylindrical heat generating material and the reaction tube; a temperature measurement chip installed between the cylindrical heat generating material and the cylindrical insulating part; and a radiation thermometer configured to measure a temperature of the temperature measurement chip, wherein the radiation thermometer is disposed below a lower end of the reaction tube.

(Supplementary Note 2)

The heat treatment apparatus according to Supplementary Note 1, wherein the temperature measurement chip is made of the same material as the cylindrical heat generating material.

(Supplementary Note 3)

The heat treatment apparatus according to Supplementary Note 1 or 2, wherein the temperature measurement chip protrudes from the cylindrical heat generating material.

(Supplementary Note 4)

The heat treatment apparatus according to Supplementary Note 1 or 2, wherein the temperature measurement chip is installed at a position spaced apart from the cylindrical heat generating material.

According to the present invention disclosed in this application, a heat treatment apparatus for growing single crystalline films or polycrystalline films on a plurality of substrates is provided, which includes: a boat configured to hold the plurality of substrates; a cylindrical heat generating material installed to surround the boat and constituting a reaction chamber; a reaction tube installed to surround the cylindrical heat generating material; a cylindrical insulating part installed between the cylindrical heat generating material and the reaction tube; a temperature measurement chip installed between the cylindrical heat generating material and the cylindrical insulating part; and a radiation thermometer configured to measure a temperature of the temperature measurement chip, wherein the radiation thermometer is disposed below a lower end of the reaction tube. Therefore, variation in measurement value due to contact of a process gas with the radiation thermometer and sticking of a byproduct to the radiation thermometer according to passage of time can be prevented, a temperature of the cylindrical heat generating material can be measured without punching a hole in the cylindrical insulating part, deterioration of temperature distribution of the cylindrical heat generating material can be prevented, and influence of radiation of the cylindrical heat generating material on the reaction tube by can be prevented.

In addition, according to the present invention disclosed in this application, since a cylindrical protection tube is installed between the temperature measurement chip and the radiation thermometer to surround an optical path through which radiant light emits from the temperature measurement chip, generation of a measurement error and deviation in measurement temperature due to intrusion of a gas or particles into the optical path of the radiant light emitted from the temperature measurement chip and blocking and polarization of the radiant light can be prevented.

Further, according to the present invention disclosed in this application, since the temperature measurement chip is fixed to an upper end of the protection tube, the temperature measurement chip and the protection tube can be integrally formed with each other, a space between the temperature measurement chip and the protection tube can be completely closed, a cost can be reduced, and intrusion of the gas and particles into the optical path of the radiant light can be effectively prevented.

In addition, according to the present invention disclosed in this application, a heat treatment apparatus for growing single crystalline films or polycrystalline films on a plurality of substrates is provided, which includes: a boat configured to hold the plurality of substrates; a cylindrical heat generating material installed to surround the boat and constituting a reaction chamber; a reaction tube installed to surround the cylindrical heat generating material; a cylindrical insulating part installed between the cylindrical heat generating material and the reaction tube; a thermocouple installed between the cylindrical heat generating material and the cylindrical insulating part; a protection tube configured to protect the thermocouple; and a heating coil to which a radio frequency current is applied to heat the cylindrical heat generating material, wherein the protection tube is made of a member having a resistance higher than that of the cylindrical heat generating material and which is not easily induction-heated by the heating coil. Therefore, since contamination of a substrate due to etching of the protection tube by a process gas can be prevented and variation in measurement value due to sticking of a byproduct of the process gas to the thermocouple according to passage of time can be prevented, reliability and reproduction of the measurement value by the thermocouple can be improved and an operation error of the thermocouple due to induction heating of the protection tube can be prevented.

Further, according to the present invention disclosed in this application, since the protection tube is made of sapphire, the induction heating of the protection tube can be further suppressed, and the operation error of the thermocouple can be more effectively prevented.

(Supplementary Note 5)

The heat treatment apparatus according to Supplementary Note 4, wherein the temperature measurement chip protrudes from the cylindrical insulating part.

(Supplementary Note 6)

The heat treatment apparatus according to Supplementary Note 1, wherein a cylindrical protection tube is installed between the temperature measurement chip and the radiation thermometer to surround an optical path through which radiant light is emitted from the temperature measurement chip to the radiation thermometer.

(Supplementary Note 7)

The heat treatment apparatus according to Supplementary Note 6, wherein the temperature measurement chip is fixed to an upper end of the protection tube.

(Supplementary Note 8)

The heat treatment apparatus according to Supplementary Note 7, wherein a member having a thermal conductivity lower than that of the temperature measurement chip is interposed between the protection tube and the temperature measurement chip.

(Supplementary Note 9)

The heat treatment apparatus according to Supplementary Notes 1 through 8, further including a mirror disposed below the lower end of the reaction tube to reflect radiant light from the temperature measurement chip, wherein the radiation thermometer measures the reflected radiant light.

(Supplementary Note 10)

The heat treatment apparatus according to Supplementary Notes 1 to 8, further including a elevating part configured to raise and lower the boat in the reaction chamber, wherein the radiation thermometer is installed in the elevating part.

(Supplementary Note 11)

A heat treatment apparatus for growing single crystalline films or polycrystalline films on a plurality of substrates, the heat treatment apparatus including: a boat configured to hold the plurality of substrates; a cylindrical heat generating material installed to surround the boat and constituting a reaction chamber; a reaction tube installed to surround the cylindrical heat generating material; a cylindrical insulating part installed between the cylindrical heat generating material and the reaction tube; a thermocouple installed between the cylindrical heat generating material and the cylindrical insulating part; a protection tube configured to protect the thermocouple; and a heating coil to which a radio frequency current is applied to heat the cylindrical heat generating material, wherein the protection tube is made of a member which has a resistance higher than that of the cylindrical heat generating material and is hardly induction-heated by the heating coil than the cylindrical heat generating material.

(Supplementary Note 12)

The heat treatment apparatus according to Supplementary Note 11, wherein the protection tube is made of sapphire.

(Supplementary Note 13)

The heat treatment apparatus according to Supplementary Note 12, further including an inlet flange including an upper flange configured to support the reaction tube, the cylindrical insulating part and the cylindrical heat generating material, and a cylindrical exhaust space configured to exhaust a process gas supplied into the reaction chamber, wherein the protection tube passes through the upper flange, and protrudes to a space isolated from the cylindrical exhaust space.

What is claimed is:

1. A heat treatment apparatus for growing a single crystalline film or a polycrystalline film on a plurality of substrates, the heat treatment apparatus comprising:
a boat configured to hold the plurality of substrates;
a cylindrical heat generating material installed to surround the boat and constituting a reaction chamber;
a reaction tube installed to surround the cylindrical heat generating material;
a cylindrical insulating part installed between the cylindrical heat generating material and the reaction tube;
a temperature measurement chip installed between the cylindrical heat generating material and the cylindrical insulating part; and
a radiation thermometer configured to measure a temperature of the temperature measurement chip,
wherein the radiation thermometer is disposed below a lower end of the reaction tube.

2. The heat treatment apparatus according to claim 1, wherein the temperature measurement chip and the cylindrical heat generating material are made of a same material.

3. The heat treatment apparatus according to claim 1, wherein the temperature measurement chip protrudes from the cylindrical heat generating material.

4. The heat treatment apparatus according to claim 1, wherein the temperature measurement chip is installed at a position spaced apart from the cylindrical heat generating material.

5. The heat treatment apparatus according to claim 4, wherein the temperature measurement chip protrudes from the cylindrical insulating part.

6. The heat treatment apparatus according to claim 1, further comprising a cylindrical protection tube installed between the temperature measurement chip and the radiation thermometer to surround an optical path of a radiant light emitted from the temperature measurement chip to the radiation thermometer.

7. The heat treatment apparatus according to claim 6, wherein the temperature measurement chip is fixed to an upper end of the protection tube.

8. The heat treatment apparatus according to claim 7, further comprising a member interposed between the protection tube and the temperature measurement chip, the member having a thermal conductivity lower than that of the temperature measurement chip.

9. The heat treatment apparatus according to claim 1, further comprising a mirror disposed below the lower end of the reaction tube to reflect a radiant light from the temperature measurement chip, wherein the radiation thermometer measures the radiant light reflected by the mirror.

10. The heat treatment apparatus according to claim 1, further comprising a elevating part configured to lift and lower the boat in the reaction chamber, wherein the radiation thermometer is installed in the elevating part.

11. A heat treatment apparatus for growing a single crystalline film or a polycrystalline film on a plurality of substrates, the heat treatment apparatus comprising:
a boat configured to hold the plurality of substrates;
a cylindrical heat generating material installed to surround the boat and constituting a reaction chamber;
a reaction tube installed to surround the cylindrical heat generating material;
a cylindrical insulating part installed between the cylindrical heat generating material and the reaction tube;
a thermocouple installed between the cylindrical heat generating material and the cylindrical insulating part;
a protection tube configured to protect the thermocouple; and
a heating coil configured to heat the cylindrical heat generating material, wherein a radio frequency current is applied to heating coil,
wherein the protection tube is made of a member having a resistance higher than that of the cylindrical heat generating material and is hardly induction-heated by the heating coil than the cylindrical heat generating material.

12. The heat treatment apparatus according to claim 11, wherein the protection tube is made of sapphire.

13. The heat treatment apparatus according to claim 12, further comprising an inlet flange including an upper flange configured to support the reaction tube, the cylindrical insulating part and the cylindrical heat generating material; and a cylindrical exhaust space configured to exhaust a process gas supplied into the reaction chamber, wherein the protection tube passes through the upper flange, and protrudes to a space isolated from the cylindrical exhaust space.

14. A method of forming a film comprising steps of:
(a) loading a boat into a reaction chamber with the boat holding a plurality of substrates; and
(b) supplying a film forming gas into the reaction chamber and forming a predetermined film on the plurality of substrates while heating a cylindrical heat generating material constituting the reaction chamber using an induction current and insulating the cylindrical heat generating material using a cylindrical insulating part installed to surround the cylindrical heat generating material,
wherein, in the step (b), a temperature of a temperature measurement chip installed between the cylindrical heat generating material and the cylindrical insulating part is measured by a radiation thermometer disposed below the reaction chamber to control a temperature in the reaction chamber.
